(19) United States
(12) Patent Application Publication
(10) Pub. No.: US 2007/0099517 A1
(43) Pub. Date: May 3, 2007

(54) Audio socket having a positioning device for positioning an audio terminal extendable into the audio socket

(76) Inventor: Huang-Chou Huang, Taipei Hsien (TW)

Correspondence Address: PATENTTM.US, P. O. BOX 82788, PORTLAND, OR, 97282-0788, US

(21) Appl. No.: 11/266,106

(22) Filed: Nov. 2, 2005

(51) Int. Cl. H01R 24/04

(52) U.S. Cl. 439/668

(57) ABSTRACT

An audio socket includes a casing, a hole defined in the casing for extension of an audio terminal, a receiving room in communication with the hole, a first resilient contact securely rested on an side face of the receiving room and provided with a fold on the first resilient contact, a fixed contact provided inside the receiving room to be opposite to the first resilient contact, a second resilient contact and a third resilient contact both adjacent to the fixed contact and securely and oppositely provided inside the receiving room. An annular block is securely provided inside the receiving room and has a positioning hole defined in the annular block for positioning the audio terminal after being extended into the hole of the casing.

### BACKGROUND OF THE INVENTION

1. Field of the Invention

The present invention relates to an audio socket, and more particularly to an audio socket having a positioning device so that after an audio terminal is extended into the audio socket, the audio terminal is securely positioned inside the audio socket.

2. Description of Related Art

With reference to FIG. 4, it is noted that a conventional audio socket includes an insulated casing (40) provided therein a channel (41) for extension of an audio terminal (50) and a receiving room (400) in communication with the channel (41) to securely receive therein a first resilient contact (42) having thereon an arc (43), a fixed contact (44) opposite to the first resilient contact (42) and a second resilient contact (45) and a third resilient contact (46) respectively provided on opposed sides of the fixed contact (44). A free end of the third resilient contact (46) is provided with a insulated block (47).

When the audio terminal (50) is inserted into the channel (41), the audio terminal (50) simultaneously engages with the arc (43) and forces the first resilient contact (42) to abut an inner side face of the channel (41). Also, the audio terminal (50) forces the second resilient contact (45) to move toward an inner side face of the channel (41), which allows the second resilient contact (45) to engage with the insulated block (47). The insulated block (47) in turn contact with the inner side face of the insulated casing (40) and thus a complete circuit between the audio terminal (50) and the audio socket is completed.

However, when the audio terminal (50) is pulled or moved resulted from intentional or unintentional force, abnormal pressure is applied to the arc (43) and the second resilient contact (45) by the audio terminal (50). After a long period of time using the conventional audio socket, the audio socket is worn and is not able to securely hold the audio terminal in place such that the audio terminal may easily become loose and bad connection between the audio terminal and the audio socket occurs.

To overcome the shortcomings, the present invention tends to provide an improved audio socket to mitigate the aforementioned problems.

### SUMMARY OF THE INVENTION

The primary objective of the present invention is to provide an audio socket having a positioning device inside the socket for position the audio terminal extendable into the socket.

In one aspect of the present invention, the positioning device is an annular block having a positioning hole defined in the annular block for receiving therein the audio terminal. Thus movement of the audio terminal after being extended into the audio socket will not cause bad connection with the audio socket.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the audio socket of the present invention;

FIG. 2 is a partially exploded perspective view of the audio socket of the present invention;

FIG. 3 is a cross sectional view taken from line 3-3 in FIG. 1; and

FIG. 4 is a cross sectional view of a conventional audio socket.

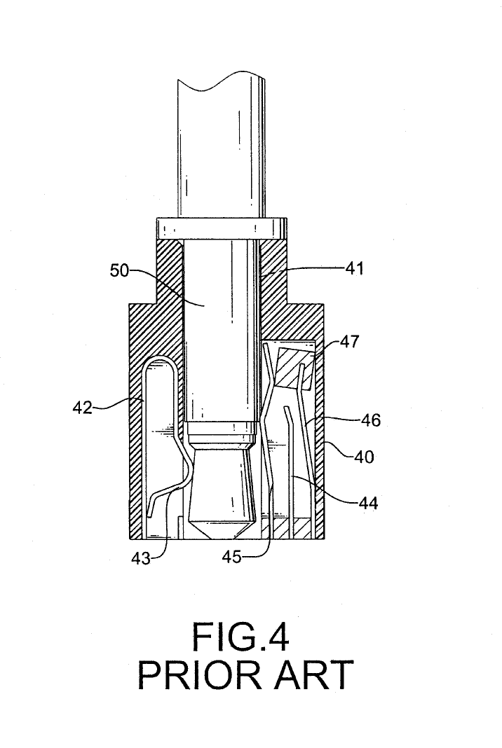

### DETAILED DESCRIPTION OF THE PREFERRED EMBODIMENT

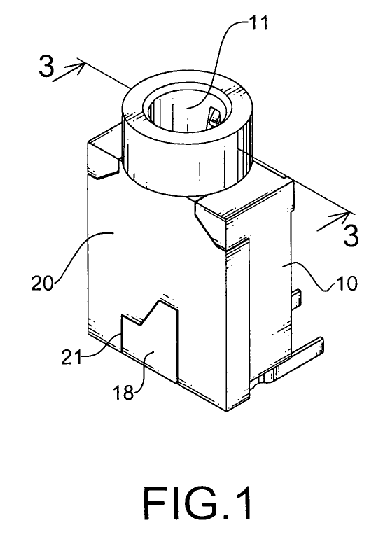

With reference to FIG. 1, it is noted that the audio socket in accordance with the present invention includes a casing (10) with a hole (11) defined in the casing (10) for extension of an audio terminal (not shown) and a side board (20) to close an opening of the casing (10).

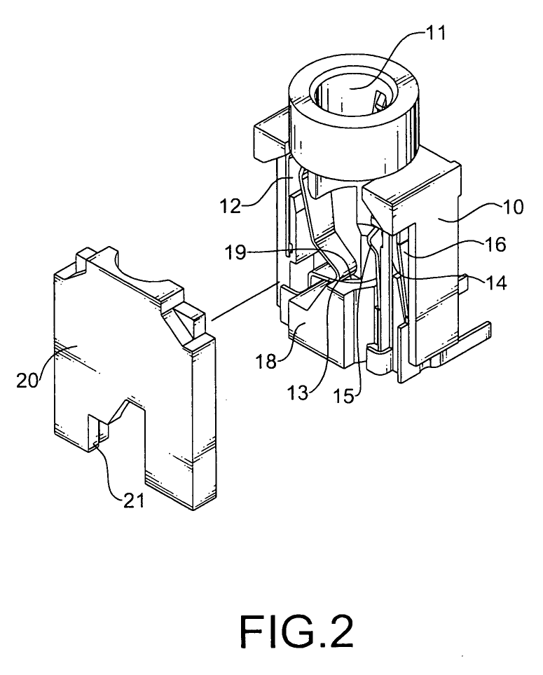

With reference to FIG. 2, it is noted that the audio socket of the present invention further has a receiving room (not numbered) in communication with the hole (11), a first resilient contact (12) securely rested on an inner side face in the receiving room inside the casing (10) and provided with a fold (13), a fixed contact (14) securely rested inside the casing (10) to be opposite to the first resilient contact (12), a second resilient contact (15) and a third resilient contact (16) being adjacent to the fixed contact (14) and placed on two opposed sides of the fixed contact (14).

Furthermore, an integrally formed annular block (18) is securely received in the casing (10) and has a positioning hole (19) to correspond to the audio terminal (not shown). To accommodate the provision of the annular block (18), the side board (20) has a cutout (21) to receive therein a portion of the annular block (18).

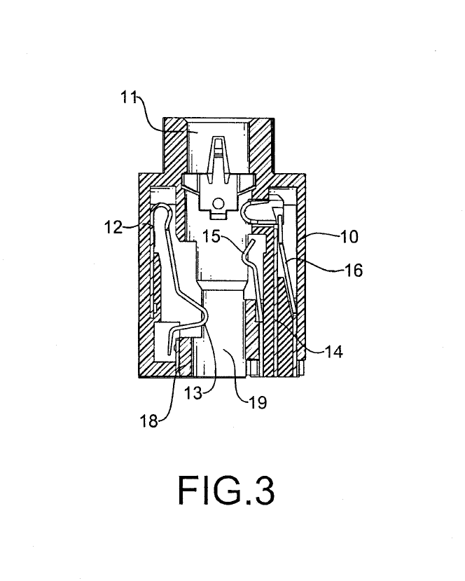

With reference to FIG. 3, it is noted that with the provision of the annular block (18), after the audio terminal is extended into the audio socket from the hole (11), the free end of the audio terminal is rested in the positioning hole (19), which provides no additional room for movement of the audio terminal except axial movement thereof (extending in and pulling out of the audio terminal). Therefore, the audio socket is protected and the life span thereof is prolonged.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. In an audio socket having a casing, a hole defined in the casing for extension of an audio terminal, a receiving room in communication with the hole, a first resilient contact securely rested on a side face of the receiving room and provided with a fold on the first resilient contact, a fixed contact provided inside the receiving room to be opposite to the first resilient contact, a second resilient contact and a third resilient contact both adjacent to the fixed contact and securely and oppositely provided inside the receiving room, wherein the improvement comprises:
an annular block is securely provided inside the receiving room and has a positioning hole defined in the annular block for positioning the audio terminal after being extended into the hole of the casing,
wherein the annular block is integrally formed with the receiving room.

2. (canceled)

3. The audio socket as claimed in claim 1 further comprising a side board to close an opening of the casing, the side board having a cutout defined in the side board to accommodate the annular block.
